(19) United States
(12) Patent Application Publication
(10) Pub. No.: US 2022/0223984 A1
(43) Pub. Date: Jul. 14, 2022

(54) RECHARGEABLE BATTERY

(71) Applicant: Samsung SDI Co., Ltd., Yongin-si, Gyeonggi-do (KR)

(72) Inventors: Jong-Ha LEE, Yongin-si (KR); Byoungmin CHUN, Yongin-si (KR); Youmee KIM, Yongin-si (KR)

(21) Appl. No.: 17/595,123

(22) PCT Filed: Jul. 28, 2020
(86) PCT No.: PCT/KR2020/009946

§ 371 Date: Nov. 9, 2021

(30) Foreign Application Priority Data
Aug. 19, 2019 (KR) 10-2019-0101312

(51) Int. Cl. H01M 50/547; H01M 10/04; H01M 50/153; H01M 50/181; H01M 50/184; H01M 50/538

(52) U.S. Cl. CPC H01M 50/547; H01M 10/0427; H01M 10/0431; H01M 50/538; H01M 50/181; H01M 50/184; H01M 50/153

(57) ABSTRACT

One aspect of the present invention is to provide a rechargeable battery that increases capacity by reducing a thickness at which an electrode terminal is installed and that easily connects a lead tab to the electrode terminal. An embodiment of the present invention provides a rechargeable battery including: an electrode assembly formed by disposing and winding a separator between a first electrode and a second electrode; a case that faces one of the wound ends of the electrode assembly and accommodates the electrode assembly; a cap plate that faces the other of the wound ends and closes and seals an opening of the case; an electrode terminal installed by interposing an insulating material in a terminal hole formed in one of the cap plate and the case; a first lead tab connecting one of the first electrode and the second electrode to the electrode terminal; and a second lead tab connecting the other of the first electrode and the second electrode to the other of the cap plate and the case.

### TECHNICAL FIELD

The present invention relates to a rechargeable battery, and more particularly, to an ultra-compact rechargeable battery.

### BACKGROUND ART

A rechargeable battery differs from a primary battery in that it can be repeatedly charged and discharged, while the latter is incapable of being recharged. A low-capacity rechargeable battery is used in a portable electronic device such as a mobile phone, a notebook computer, and a camcorder, and a large-capacity rechargeable battery is widely used as a power source for driving a motor of a hybrid vehicle and the like.

As typical rechargeable batteries, there are a nickel-cadmium (Ni—Cd) battery, a nickel-hydrogen (Ni-MH) battery, a lithium (Li) battery, a lithium ion (Li-ion) rechargeable battery, etc. Particularly, the Li-ion rechargeable battery has an operating voltage that is three times as high as those of the Ni—Cd battery and the Ni-MH battery that are widely used as a power supply for portable electronic devices. In addition, the lithium ion rechargeable battery has been widely used because its energy density per unit weight is high.

Particularly, as demand for wearable devices such as a headphone, an earphone, a smartwatch, and a body-worn medical device using Bluetooth has increased, a need for a rechargeable battery having a high energy density and an ultra-small size has been increasing.

As an example, the ultra-small rechargeable battery includes a coin cell or a button cell. Since the coin cell or button cell has a low overall height, when a thickness of a portion in which an electrode terminal thereof is installed increases, battery capacity may be reduced. In addition, since end portions of a bent lead tab are adjacent to both ends of an electrode assembly wound with a lower height than a diameter thereof, workability for welding end portions of the lead tab and the electrode terminal is deteriorated.

### DISCLOSURE

One aspect of the present invention is to provide a rechargeable battery that increases capacity by reducing a thickness at which an electrode terminal is installed and that easily connects a lead tab to the electrode terminal.

An embodiment of the present invention provides a rechargeable battery including: an electrode assembly formed by disposing and winding a separator between a first electrode and a second electrode; a case that faces one of the both wound ends of the electrode assembly and accommodates the electrode assembly; a cap plate that faces the other of the wound both ends and closes and seals an opening of the case; an electrode terminal installed by interposing an insulating material in a terminal hole formed in one of the cap plate and the case; a first lead tab connecting one of the first electrode and the second electrode to the electrode terminal; and a second lead tab connecting the other of the first electrode and the second electrode to the other of the cap plate and the case.

The rechargeable battery according to the embodiment of the present invention may further include a terminal plate coupled to the electrode terminal and connected to the first lead tab together with the electrode terminal.

The insulation material may include a first gasket disposed at the outside of the terminal hole in a thickness direction of the cap plate and inserted into an inner surface of the terminal hole, and a second gasket disposed at the inside of the terminal hole and coupled to an inserted outer surface of the first gasket, and the terminal plate may be disposed inside the second gasket.

The electrode terminal may include a first plate portion extending from and supported on an outer surface of the first gasket, a pillar portion connected to the first plate portion and inserted into the first gasket portion, and a second plate portion connected to the pillar portion and extending from and supported on an inner surface of the terminal plate.

The second gasket may be provided with a protrusion protruding from an outer circumference thereof toward the electrode assembly to form a gap between an inner circumferential surface of the protrusion and an outer circumferential surface of the terminal plate.

The terminal plate may be coupled to the pillar portion to be connected to the second plate portion, and the second lead tab may be connected to the case.

The terminal hole may be formed in the cap plate, the first gasket may be disposed on the outside of the cap plate, and the second gasket may be disposed on the inside of the cap plate.

The first gasket may be provided with an insertion portion inserted into the terminal hole, and a diameter of the terminal hole and an inner diameter of the second gasket may be the same as an outer diameter of the insertion portion.

The cap plate may be provided with a first accommodating groove having a step to accommodate the first gasket.

The terminal plate may be provided with a second accommodating groove having a step to accommodate the second plate portion, and a lower end of the insertion portion may form the same plane as the second accommodating groove.

An upper surface of the second plate portion may support the second accommodating groove of the terminal plate and a lower end of the insertion portion.

The rechargeable battery according to the embodiment of the present invention may further include a first insulating member interposed between the second lead tab and the electrode assembly, in a bottom side of the case.

The rechargeable battery according to the embodiment of the present invention may further include a second insulating member interposed between the first lead tab and the electrode assembly, in the cap plate side.

The rechargeable battery according to the embodiment of the present invention may further include a third insulating member interposed between the first lead tab and the cap plate.

A height (H) may be set as a minimum distance between outer planes of the case and the cap plate, a diameter (D) may be set as a maximum distance of an outer circumference of the case, and a ratio of the height to the diameter may be 1 or less (H/D≤1).

The terminal plate may be coupled to the pillar portion to be connected to the second plate portion, and the second lead tab may be connected to the cap plate.

The terminal hole may be formed in the case, the first gasket may be disposed on the outside of the case, and the second gasket may be disposed on the inside of the case.

The case may be provided with a first accommodating groove having a step to accommodate the first gasket.

The terminal plate may be provided with a second accommodating groove having a step to accommodate the second plate portion, an upper end of the insertion portion may form the same plane as the second accommodating groove, and a lower surface of the second plate portion may be supported on the second accommodating groove of the terminal plate and an upper end of the insertion portion.

The rechargeable battery according to the embodiment of the present invention may further include: a first insulating member interposed between the second lead tab and the electrode assembly, in the cap plate side; a second insulating member interposed between the first lead tab and the electrode assembly, in a bottom side of the case; and a third insulating member interposed between the first lead tab and the bottom of the case.

As such, according to the embodiment of the present invention, by interposing an insulating material in a terminal hole formed in a case or cap plate to install an electrode terminal and by connecting the electrode terminal to an electrode assembly with a first lead tab, it is possible to increase capacity by reducing a thickness at which the electrode terminal is installed.

In addition, according to the embodiment of the present invention, by laser-welding a first lead tab to a second plate portion or terminal plate having a thin thickness of an electrode terminal, it is possible to easily connect the first lead tab and the electrode terminal.

### DESCRIPTION OF THE DRAWINGS

FIG. 1 illustrates an exploded perspective view of a rechargeable battery according to a first embodiment of the present invention.

FIG. 2 illustrates a cross-sectional view taken along line II-II of FIG. 1.

FIG. 3 specifically illustrates a cross-sectional view of a coupling state between a terminal hole and an electrode terminal formed in a cap plate of FIG. 2.

FIG. 4 illustrates an exploded perspective view of a rechargeable battery according to a second embodiment of the present invention.

FIG. 5 illustrates a cross-sectional view taken along line V-V of FIG. 4.

FIG. 6 specifically illustrates a cross-sectional view of a coupling state between a terminal hole and an electrode terminal formed in a case of FIG. 5.

### MODE FOR INVENTION

The present invention will be described more fully hereinafter with reference to the accompanying drawings, in which embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

A rechargeable battery according to an embodiment of the present invention is an ultra-small battery, and may be a coin cell or button cell. Here, the coin cell or button cell is a thin coin-type or button-type cell, which means a battery having a ratio (height/diameter) of a height to a diameter of 1 or less.

Since the coin cell or the button cell is mainly cylindrical, a horizontal cross-section is circular, but the present invention is not limited thereto, and a horizontal cross-section may be oval or polygonal. In this case, the diameter means a maximum distance based on a horizontal direction of the battery, and the height means a minimum distance from a flat bottom surface of the battery to a flat top surface of the battery.

However, the present invention is not limited to the coin cell or the button cell that is an example of the present invention, and a battery of the present invention may be a cylindrical-type or pin-type of battery. However, hereinafter, a case in which a rechargeable battery according to an embodiment of the present invention is a coin cell or a button cell will be exemplarily described in detail.

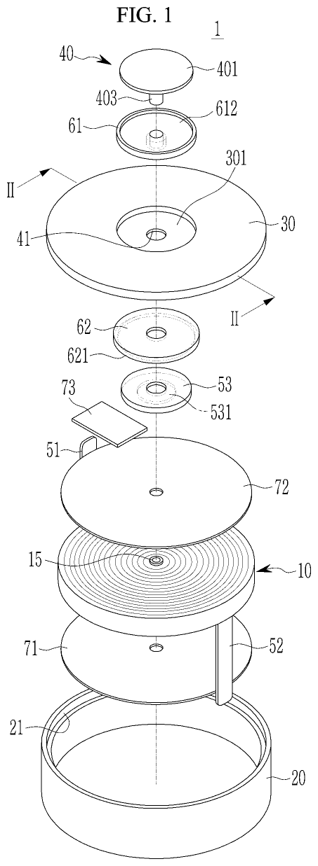

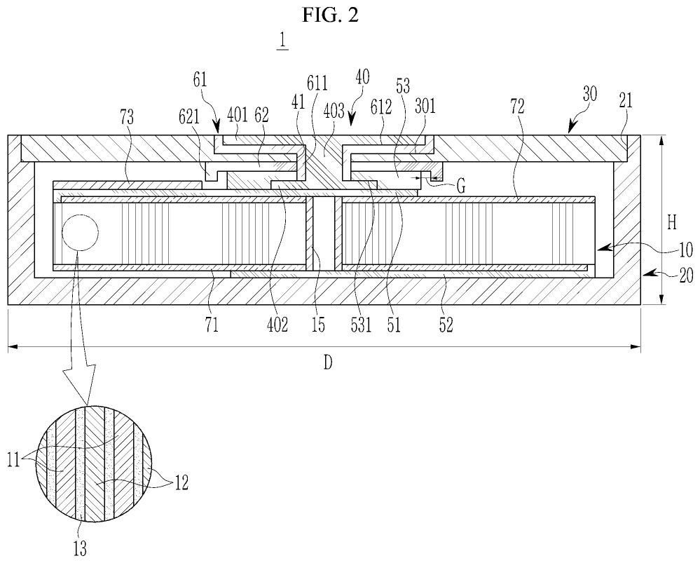

FIG. 1 illustrates an exploded perspective view of a rechargeable battery according to a first embodiment of the present invention, and FIG. 2 illustrates a cross-sectional view taken along line II-II of FIG. 1. Referring to FIG. 1 and FIG. 2, a rechargeable battery 1 of the first embodiment includes an electrode assembly 10, a case 20, a cap plate 30, an electrode terminal 40, a first lead tab 51, a second lead tab 52, and a terminal plate 53.

The electrode assembly 10 includes a first electrode 11 (for example, a negative electrode) and a second electrode 12 (for example, a positive electrode) provided on respective surfaces of a separator 13 that is an electrical insulating material, and is formed by winding the first electrode 11, the separator 13, and the second electrode 12. Accordingly, the electrode assembly 10 may have a jelly-roll shape, and is configured to charge and discharge a current.

In this case, a winding axis of the electrode assembly 10 may be arranged in parallel with a height direction of the case 20, and a lower surface (one of respective ends of winding) of the electrode assembly 10 and an upper surface (the other of respective ends of winding) thereof may be flat and parallel to each other.

The electrode assembly 10 is provided with a center pin 15 at a position of the winding axis. When the first and second lead tabs 51 and 52 are welded to the electrode terminal 40 and the case 20, the center pin 15 allows the first lead tab 51 and the electrode terminal 40 to be in close contact with each other and allows the second lead tab 52 and the case 20 to be in close contact with each other, so that it is possible to improve welding performance. The center pin 15 may be formed as a cylinder to allow a gas and an electrolyte to flow therein. In addition, the center pin may be formed in a circular cylindrical shape (not shown).

Hereinafter, in the description, a case in which the first electrode 11 and the second electrode 12 are respectively a negative electrode and a positive electrode will be exemplarily described, but the present invention is not limited thereto, and the first electrode 11 and the second electrode 12 may respectively be a positive electrode and a negative electrode.

The negative electrode 11 (first electrode) is formed in a long extending strip shape, and includes a negative electrode coated region that is a region in which a negative electrode active material layer is coated to a current collector of a metal foil (for example, a Cu foil) and a negative electrode uncoated region that is a region in which an active material is not coated. The negative electrode uncoated region may be disposed at one end portion in a length direction of the negative electrode.

The positive electrode 12 (second electrode) is formed in a long extending strip shape, and includes a positive electrode coated region that is a region in which a positive electrode active material layer is coated to a current collector of a metal foil (for example, an Al foil) and a positive electrode uncoated region that is a region in which an active material is not coated. The positive electrode uncoated region may be disposed at one end portion in a length direction of the positive electrode.

The case 20 allows the electrode assembly 10 to be inserted and accommodated through an opening 21 formed in one side thereof. The case 20 sets a space in which the electrode assembly 10 and an electrolyte are accommodated. For example, the case 20 may have a cylindrical shape with a low height, and may be provided with the circular opening 21 for inserting the cylindrical electrode assembly 10 at an upper end thereof.

The cap plate 30 closes and seals the opening 21 of the case 20, and is coupled to the opening 21 to be closed and sealed by welding. The electrode terminal 40 is installed in a terminal hole 41 formed in the cap plate 30 with an insulating material interposed therebetween. That is, the electrode terminal 40 and the cap plate 30 have different polarities.

In the electrode assembly 10, the first lead tab 51 (negative electrode tab) is fixedly installed on the negative electrode 11, and the second lead tab 52 (positive electrode tab) is fixedly installed on the positive electrode 12. Accordingly, in the first embodiment, the electrode terminal 40 has a negative polarity, and the cap plate 30 has a positive polarity. Although not separately shown, the electrode terminal 40 may have a positive polarity, and the cap plate 30 may have a negative polarity.

The first lead tab 51 and the second lead tab 52 may be respectively installed in the negative uncoated region and the positive electrode uncoated region, extend parallel to the winding axis, and then have end portions bent toward the winding axis. For example, the bent end portions of the first lead tab 51 and the second lead tab 52 may be disposed on an upper portion (a cap plate 30 side) and a lower portion (a case 20 side) of the electrode assembly 10, respectively.

The first lead tab 51 is made of an electrically conductive material such as copper or nickel, and is electrically connected to the electrode terminal 40 directly or through the terminal plate 53. For example, the bent end portion of the first lead tab 51 may be connected to the electrode terminal 40 or the terminal plate 53 by laser welding.

That is, the terminal plate 53 may be mechanically coupled to the electrode terminal 40, and the terminal plate 53 may be connected to the bent end portion of the second lead tab 52 together with the electrode terminal 40 by laser welding.

The second lead tab 52 is made of an electrically conductive material such as nickel or aluminum, and is electrically connected to the case 20. For example, the bent end portion of the second lead tab 52 may be connected to an inner bottom surface of the case 20 by laser welding.

Insulating materials interposed between the electrode terminal 40 and the terminal hole 41 and around the electrode terminal 40 include a first gasket 61 and a second gasket 62. The first gasket 61 is disposed at the outside of the terminal hole 41 to be inserted into the terminal hole 41, so it electrically insulates between the electrode terminal 40 and the terminal hole 41 and between the electrode terminal 40 and the cap plate 30 at the outside of the cap plate 30.

Since the second gasket 62 is disposed at the inside the terminal hole 41 to be coupled to an outside thereof in which the first gasket 61 is inserted, it electrically insulates between the electrode terminal 40 and the cap plate 30 inside the cap plate 30.

The outside means an outer side of the rechargeable battery 1 in a thickness direction of the cap plate 30, and the inside means an inner side of the rechargeable battery 1 in the thickness direction of the cap plate 30.

The terminal plate 53 is disposed at the inside of the second gasket 62, and is electrically connected to the electrode terminal 40. Accordingly, the second gasket 62 further electrically insulates between the terminal plate 53 and the cap plate 30.

As an example, the electrode terminal 40 is formed as a rivet, and a completed structure thereof is formed after a riveting process. The first gasket 61 is interposed in the terminal hole 41 at the outside of the cap plate 30 to insert a rivet in a state before the electrode terminal 40 is formed, and the second gasket 62 and the terminal plate 53 are coupled to an outer surface of the first gasket 61 at the inside of the cap plate 30, and then the rivet is deformed to form the electrode terminal 40.

After riveting, the electrode terminal 40 includes a first plate portion 401, a pillar portion 403, and a second plate portion 402. The first plate portion 401 is extended and supported in a wide area on an outer surface of the first gasket 61. The second plate portion 402 is extended and supported in a wide area on an inner surface of the terminal plate 53. The pillar portion 403 is inserted into the first gasket 61 to connect the first plate portion 401 and the second plate portion 402 to each other.

Accordingly, while the first and second plate portions 401 and 402 are disposed at the outside and inside of the terminal hole 41 with the cap plate 30 therebetween and while the first and second gaskets 61 and 62 and the terminal plate 53 are installed in the terminal hole 41, the electrode terminal 40 is installed.

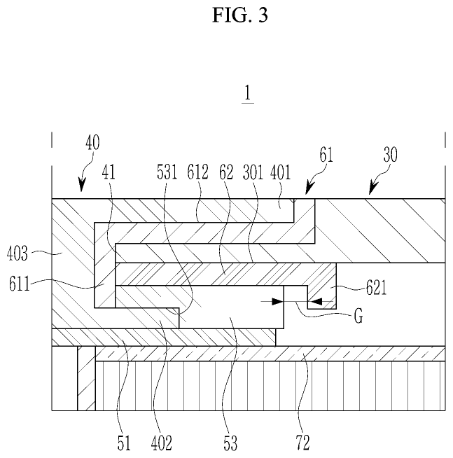

FIG. 3 specifically illustrates a cross-sectional view of a coupling state between a terminal hole and an electrode terminal formed in a cap plate of FIG. 2. Referring to FIG. 2 and FIG. 3, the second gasket 62 is provided with a protrusion 621 protruding from an exterior circumference thereof towards the electrode assembly 10.

In a diameter direction of the cap plate 30, the terminal plate 53 is coupled to the inside of the protrusion 621 of the second gasket 62. The terminal plate 53 is coupled to the inner surface of the second gasket 62. In this case, a gap (G) is formed between an inner circumferential surface of the protrusion 621 and an outer circumferential surface of the terminal plate 53 in the diameter direction. The gap (G) forms an assembly tolerance of the terminal plate 53, and may accommodate a deformation amount of the terminal plate 53 due to a riveting pressure deviation.

In the first embodiment, the terminal plate 53 connected to the first lead tab 51 is coupled to the pillar portion 403 of the electrode terminal 40 to be connected to the second plate portion 402, and the second lead tab 52 is connected to the case 20.

The terminal hole 41 is formed in the cap plate 30, the first gasket 61 is disposed on the outside of the cap plate 30, and the second gasket 62 is disposed on the inside of the cap plate 30.

The first gasket 61 is provided with an insertion portion 611 that is inserted into the terminal hole 41, and a diameter of the terminal hole 41 and an inner diameter of the second gasket 62 are the same as an outer diameter of the insertion portion 611. Accordingly, the second gasket 62 may be coupled to the first gasket 61 in an airtight structure inside the cap plate 30.

The cap plate 30 is provided with a first accommodating groove 301 on an outer surface having a step to accommodate the first gasket 61. Accordingly, the first gasket 61 inserted from the outside of the cap plate 30 is accommodated in the first accommodating groove 301 so that an outer surface of the first gasket 61 and an outer surface of the cap plate 30 may form the same horizontal plane. Accordingly, a thickness of a portion in which the electrode terminal 40 is installed is decreased at the outside, and thus capacity may be increased.

In addition, the first plate portion 401 of the electrode terminal 40 is coupled to a third accommodating groove 612 formed on an outer surface of the first gasket 61, so that an outer surface of the first plate portion 401 and an outer surface of the first gasket 61 may form the same horizontal plane. Accordingly, the thickness of the portion in which the electrode terminal 40 is installed is further decreased at the outside, and thus the capacity may be further increased.

The terminal plate 53 is provided with a second accommodating groove 531 having a step difference to accommodate the second plate portion 402. Accordingly, by accommodating the second plate portion 402 formed inside the cap plate 30, an inner surface of the second plate portion 402 and an inner surface of the terminal plate 53 may form the same horizontal plane. Accordingly, the thickness of the portion in which the electrode terminal 40 is installed is decreased from the inside, and thus the capacity may be increased.

In this case, an upper surface of the second plate portion 402 supports lower ends of the second accommodating groove 531 of the terminal plate 53 and the insertion portion 611 of the first gasket 61. That is, the lower end of the insertion portion 611 of the first gasket 61 forms the same plane as the second accommodating groove 531, so that an inner surface of the second plate portion 402 and an inner surface of the terminal plate 53 may form the same horizontal plane.

The first lead tab 51 is directly laser-welded to the second plate portion 402 with a thin thickness, or is mechanically coupled to the pillar portion 403 to be electrically connected to the second plate portion 402 and to be laser-welded to the terminal plate 53 with a thin thickness, so the process of connecting the first lead tab 51 to the electrode terminal 40 is facilitated.

In addition, the second lead tab 51 is directly laser-welded to a bottom of the case 20. In this case, the center pin 15 supports the first and second lead tabs 51 and 52 to allow the first lead tab 51 and the electrode terminal 40 to closely contact each other and to allow the second lead tab 52 and the case 20 to closely contact each other, thereby improving each welding performance.

Referring back to FIG. 1 and FIG. 2, the rechargeable battery 1 of the first embodiment further includes a first insulating member 71 interposed between the second lead tab 52 and the electrode assembly 10, in a bottom side of the case 20. The first insulating member 71 electrically insulates between the electrode assembly 10 and the bent second lead tab 52.

The rechargeable battery 1 of the first embodiment further includes, in the cap plate 30 side, a second insulating member 72 interposed between the first lead tab 51 and the electrode assembly 10, and a third insulating member 73 interposed between the first lead tab 51 and the cap plate 30.

The second insulating member 72 electrically insulates between the electrode assembly 10 and the bent first lead tab 51. The third insulating member 73 further electrically insulates between the bent first lead tab 51 and the cap plate 30.

In the present embodiment, the first and second insulating members 71 and 72 have a through hole through which the center pin 15 passes so that the center pin 15 more firmly supports the first and second lead tabs 51 and 52. Although not shown, the first and second insulating members are not provided with a through hole, and the center pin may supports the first and second insulating members to support the first and second lead tabs.

Although not shown, the electrode assembly 10 is covered with an insulating tape along an outer circumferential surface in a diameter direction. The insulating tape electrically insulates the external circumferential surface of the electrode assembly 10 from the inner surface of the case 20, while protecting the outside of the electrode assembly 10.

When the rechargeable battery 1 of the first embodiment is applied to a coin cell or a button cell, the height (H) is set to a minimum distance between the outer planes of the case 20 and the cap plate 30, and the diameter D is set to a maximum distance of the outer circumference of the case 20. In addition, a ratio of the height H to the diameter D is 1 or less (H/D≤1).

As described above, in the case of the coin cell or the button cell with a low height compared with a diameter, since the connection structure between the electrode terminal 40 and the first lead tab 51 is thinly formed, when they have the same height (H) and diameter (D), compared with a case in which the connection structure is thick, as a size of the electrode assembly 10 increases, the overall capacity of the rechargeable battery 1 may increase.

Hereinafter, a second embodiment of the present invention will be described. Compared with the first embodiment, the same components are omitted, and different components are described.

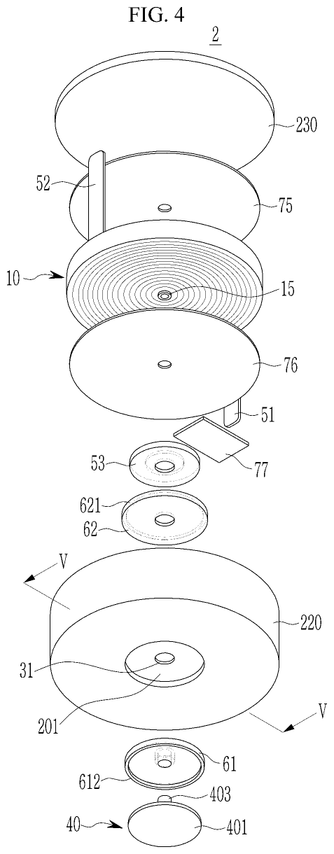

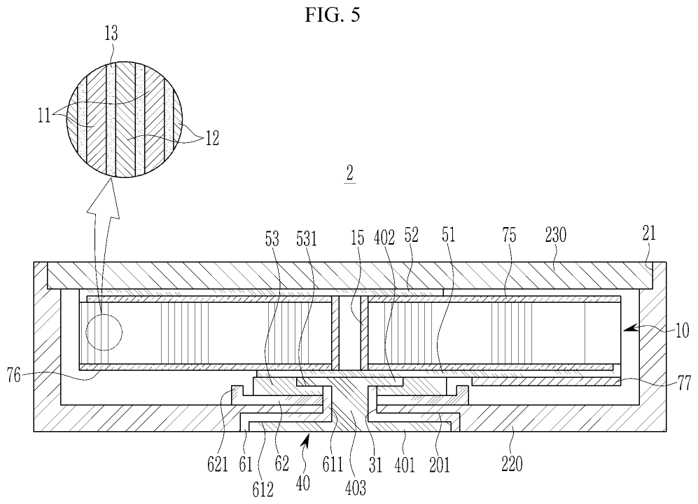

FIG. 4 illustrates an exploded perspective view of a rechargeable battery according to a second embodiment of the present invention, and FIG. 5 illustrates a cross-sectional view taken along line V-V of FIG. 4. Referring to FIG. 4 and FIG. 5, as in the rechargeable battery 1 of the first embodiment, the terminal plate 53 is connected to the second plate portion 402 of the electrode terminal 40.

In the rechargeable battery 2 of the second embodiment, the second lead tab 52 is electrically connected to a cap plate 230. For example, the bent end portion of the second lead tab 52 may be connected to an inner surface of the cap plate 230 by laser welding.

A terminal hole 31 is formed in a case 220. The first gasket 61 is disposed at the outside of the case 220 and inserted into the terminal hole 31, so it electrically insulates between the electrode terminal 40 and the terminal hole 41 and between the electrode terminal 40 and the case 200 at the outside of the case 220.

The second gasket 62 is disposed inside the case 220 and is disposed inside the terminal hole 31 to be coupled to an inserted outer surface of the first gasket 61, so that it electrically insulates between the electrode terminal 40 and the case 220 at the inside of the case 220.

The outside means an outer side of the rechargeable battery 2 in a thickness direction of a bottom of the case 200, and the inside means an inner side of the rechargeable battery 2 in the thickness direction of the bottom of the case 220.

The terminal plate 53 is disposed at the inside of the second gasket 62, and is electrically connected to the electrode terminal 40. Accordingly, the second gasket 62 further electrically insulates between the terminal plate 53 and the case 220.

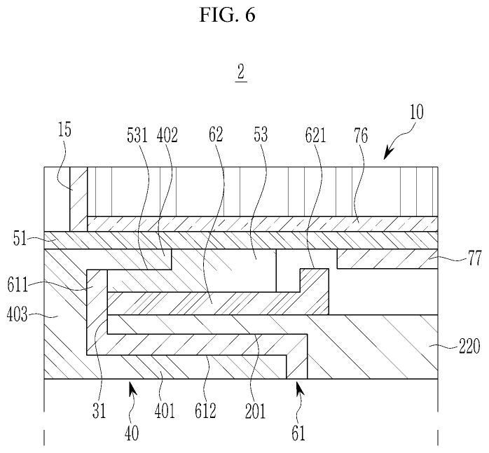

FIG. 6 specifically illustrates a cross-sectional view of the coupling state between the terminal hole and the electrode terminal formed in the case of FIG. 5. Referring to FIG. 5 and FIG. 6, the case 220 is provided with a first accommodating groove 201 on an outer surface having a step to accommodate the first gasket 61.

Accordingly, the first gasket 61 inserted from the outside of the case 220 is accommodated in the first accommodating groove 201 so that an outer surface of the first gasket 61 and an outer surface of the case 220 may form the same horizontal plane. Accordingly, a thickness of a portion in which the electrode terminal 40 is installed is decreased at the outside, and thus capacity may be increased.

The terminal plate 53 is provided with a second accommodating groove 531 having a step difference to accommodate the second plate portion 402. Accordingly, by accommodating the second plate portion 402 formed inside the case 220, an inner surface of the second plate portion 402 and an inner surface of the terminal plate 53 may form the same horizontal plane. Accordingly, the thickness of the portion in which the electrode terminal 40 is installed is decreased from the inside, and thus the capacity may be increased.

In this case, a lower surface of the second plate portion 402 is supported on lower ends of the second accommodating groove 531 of the terminal plate 53 and the insertion portion 611 of the first gasket 61. That is, the upper end of the insertion portion 611 of the first gasket 61 forms the same plane as the second accommodating groove 531, so that an inner surface of the second plate portion 402 and an inner surface of the terminal plate 53 may form the same horizontal plane.

Referring back to FIG. 4 and FIG. 5, the rechargeable battery 2 of the second embodiment further includes a first insulating member 71 interposed between the second lead tab 52 and the electrode assembly 10, in the cap plate 230 side. The first insulating member 75 electrically insulates between the electrode assembly 10 and the bent second lead tab 52.

The rechargeable battery 2 of the second embodiment further includes, in the bottom side of the case 200, a second insulating member 76 interposed between the first lead tab 51 and the electrode assembly 10, and a third insulating member 77 interposed between the first lead tab 51 and the case 220.

The second insulating member 76 electrically insulates between the electrode assembly 10 and the bent first lead tab 51. The third insulating member 77 further electrically insulates between the bent first lead tab 51 and the bottom of the case 220.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 1, 2: rechargeable battery | 10: electrode assembly |
| 11: first electrode (negative electrode) | |
| 12: second electrode (positive electrode) | |
| 13: separator | 20, 220: case |
| 21: opening | 30, 230: cap plate |
| 31, 41: terminal hole | 40: electrode terminal |
| 51: first lead tab | 52: second lead tab |
| 53: terminal plate | 61: first gasket |
| 62: second gasket | 71, 75: first insulating member |
| 72, 76: second insulating members | 73, 77: third insulating member |
| 201, 301: first accommodating groove | |
| 401: first plate portion | |
| 402: second plate portion | 403: pillar portion |
| 531: second accommodating groove | 611: insertion portion |
| 621: protrusion | D: diameter |
| G: gap | H: height |

1. A rechargeable battery comprising:
an electrode assembly formed by disposing and winding a separator between a first electrode and a second electrode;
a case that faces one of wound ends of the electrode assembly and accommodates the electrode assembly;
a cap plate that faces the other of the wound ends and closes and seals an opening of the case;
an electrode terminal installed by interposing an insulating material in a terminal hole formed in one of the cap plate and the case;
a first lead tab connecting one of the first electrode and the second electrode to the electrode terminal; and
a second lead tab connecting the other of the first electrode and the second electrode to the other of the cap plate and the case.

2. The rechargeable battery of claim 1, further comprising
a terminal plate coupled to the electrode terminal and connected to the first lead tab together with the electrode terminal.

3. The rechargeable battery of claim 2, wherein
the insulation material includes a first gasket disposed at the outside of the terminal hole in a thickness direction of the cap plate and inserted into an inner surface of the terminal hole, and
a second gasket disposed at the inside of the terminal hole and coupled to an inserted outer surface of the first gasket, and
the terminal plate is disposed inside the second gasket.

4. The rechargeable battery of claim 3, wherein
the electrode terminal includes
a first plate portion extending from and supported on an outer surface of the first gasket,
a pillar portion connected to the first plate portion and inserted into the first gasket portion, and
a second plate portion connected to the pillar portion and extending from and supported on an inner surface of the terminal plate.

5. The rechargeable battery of claim 4, wherein
the second gasket is provided with a protrusion protruding from an outer circumference thereof toward the electrode assembly to form a gap between an inner circumferential surface of the protrusion and an outer circumferential surface of the terminal plate.

6. The rechargeable battery of claim 4, wherein
the terminal plate is coupled to the pillar portion to be connected to the second plate portion, and
the second lead tab is connected to the case.

7. The rechargeable battery of claim 6, wherein
the terminal hole is formed in the cap plate,
the first gasket is disposed on the outside of the cap plate, and
the second gasket is disposed on the inside of the cap plate.

8. The rechargeable battery of claim 5, wherein
the first gasket is provided with an insertion portion inserted into the terminal hole, and
a diameter of the terminal hole and an inner diameter of the second gasket are the same as an outer diameter of the insertion portion.

9. The rechargeable battery of claim 8, wherein
the cap plate is provided with a first accommodating groove having a step to accommodate the first gasket.

10. The rechargeable battery of claim 8, wherein
the terminal plate is provided with a second accommodating groove having a step to accommodate the second plate portion, and
a lower end of the insertion portion forms the same plane as the second accommodating groove.

11. The rechargeable battery of claim 10, wherein
an upper surface of the second plate portion supports the second accommodating groove of the terminal plate and a lower end of the insertion portion.

12. The rechargeable battery of claim 6, further comprising
a first insulating member interposed between the second lead tab and the electrode assembly, in a bottom side of the case.

13. The rechargeable battery of claim 12, further comprising
a second insulating member interposed between the first lead tab and the electrode assembly, in the cap plate side.

14. The rechargeable battery of claim 13, further comprising
a third insulating member interposed between the first lead tab and the cap plate.

15. The rechargeable battery of claim 1, wherein
a height (H) is set as a minimum distance between outer planes of the case and the cap plate,
a diameter (D) is set as a maximum distance of an outer circumference of the case, and
a ratio of the height to the diameter is 1 or less (H/D≤1).

16. The rechargeable battery of claim 4, wherein
the terminal plate is coupled to the pillar portion to be connected to the second plate portion, and
the second lead tab is connected to the cap plate.

17. The rechargeable battery of claim 16, wherein
the terminal hole is formed in the case,
the first gasket is disposed on the outside of the case, and
the second gasket is disposed on the inside of the case.

18. The rechargeable battery of claim 16, wherein
the case is provided with a first accommodating groove having a step to accommodate the first gasket.

19. The rechargeable battery of claim 16, wherein
the terminal plate is provided with a second accommodating groove having a step to accommodate the second plate portion,
an upper end of the insertion portion forms the same plane as the second accommodating groove, and
a lower surface of the second plate portion is supported on the second accommodating groove of the terminal plate and an upper end of the insertion portion.

20. The rechargeable battery of claim 19, further comprising:
a first insulating member interposed between the second lead tab and the electrode assembly, in the cap plate side;
a second insulating member interposed between the first lead tab and the electrode assembly, in a bottom side of the case; and
a third insulating member interposed between the first lead tab and the bottom of the case.
